(19) United States
(12) Patent Application Publication
(10) Pub. No.: US 2026/0024281 A1
(43) Pub. Date: Jan. 22, 2026

(54) METHOD FOR DIGITAL MODELING OF A THREE-DIMENSIONAL SURFACE OF AN OBJECT

(71) Applicant: TECHNODIGIT, Lyon (FR)

(72) Inventor: David Wendland, Neyron (FR)

(21) Appl. No.: 19/273,662

(22) Filed: Jul. 18, 2025

(30) Foreign Application Priority Data
Jul. 19, 2024 (FR) 2408012

(51) Int. Cl. G06T 17/20

(52) U.S. Cl. CPC G06T 17/20; G06T 2200/04; G06T 2210/12; G06T 2210/62

(57) ABSTRACT

Method for digitally digitising a three-dimensional surface, comprising the steps of: determining coordinates of points on the three-dimensional surface to obtain a point cloud and capturing images of the three-dimensional surface; constructing by tetrahedrisation a grid of triangles on the point cloud, projecting the grid onto the images and simultaneously determining an opacity parameter and a texture parameter of the triangles by coinciding at least some of the images and the grid, in order to obtain a three-dimensional model blank, comparing the three-dimensional model blank to the images and verifying consistency between the three-dimensional model blank and the images, returning to determining the opacity and texture parameters of the triangles if the consistency is less than an expected consistency, extracting the surface from the model blank to form the three-dimensional model, otherwise.

### FIELD

The present invention relates to the field of digital modelling of three-dimensional surface.

### BACKGROUND

For example, three-dimensional digital models are used in the field of virtual reality to represent objects that a viewer can view randomly along different directions of observation or places in which a viewer can randomly move and look by rendering to the viewer an impression of volume as close as possible to reality.

The production of a three-dimensional digital model of an object generally starts by determining positions of points belonging to the outer surface of the object to obtain a point cloud and continues with determining a grid connecting these points to one another. Once the grid is complete, a texture of the surface is extracted from images of the object and applied to the grid.

The positions of the points are, for example, determined by using a digitising method by projecting a laser beam or by projecting structured light, or by a photogrammetry method.

Determining the grid is, for example, carried out by a Delaunay triangulation consisting of producing a grid from triangles, the vertices of which are the points the positions of which have been determined (also called tessellation) or, for volume surfaces, a “tetrahedrisation” consisting of producing a grid from tetrahedra having triangular faces having vertices coinciding with the points the positions of which have been determined.

Once the grid is produced, the images of the object are used to extract a texture from this, which will be applied to each triangle of the grid.

This embodiment of three-dimensional digital models is effective for simple-shaped objects. However, for objects having complex shapes, the difficulty is to determine which triangles belong to the surface of the object and which triangles do not belong to these. Triangles belonging to the surface of the object are then defined as opaque, they will be visible, while triangles not belonging to this surface are defined as transparent, they will therefore be invisible. Determining the opacity of the triangles is done by a region growth algorithm but is often imperfect, unless there is a particularly long and fastidious human intervention, such that three-dimensional digital models of complex-shaped objects often have defects.

The invention aims, in particular, to provide a three-dimensional digital model having relatively few defects by limiting the computational resources required for the modelling.

### SUMMARY

To this end, a method for digitally digitising a three-dimensional surface is provided, according to the invention, comprising the steps of: determining coordinates of points on the three-dimensional surface to obtain a point cloud and capturing images of the three-dimensional surface from a plurality of viewpoints; constructing, by tetrahedrisation, a grid of triangles on the point cloud, projecting the grid onto the images and simultaneously determining an opacity parameter and a texture parameter of the triangles by making at least some of the images coincide with the grid in order to obtain a three-dimensional model blank, comparing the three-dimensional model blank with the images and verifying consistency between the three-dimensional model blank and the images, returning to determining the opacity and texture parameters of the triangles if the consistency is less than an expected consistency, otherwise extracting the surface from the model blank to form the three-dimensional model.

Projecting the triangles onto the images and determining the texture make it possible to determine if a triangle belongs to the visible surface of the object along the direction of observation. It is noted that, as the images of the three-dimensional surface are taken from a plurality of viewpoints, the plurality of images captured from the plurality of viewpoints (and therefore along different directions of observation) provides three-dimensional information of the three-dimensional surface. Comparing the three-dimensional model blank with the plurality of images makes it possible to take into account this three-dimensional information and ultimately to make the three-dimensional model blank and said images coincide, by successive iterations, in order to converge towards a final model representative of the surface of the object, such as it appears on said images. Thus, while the images are traditionally used only to provide the texture of the model, the method of the invention utilises the images taken from a plurality of viewpoints, also for determining the opacity of the triangles by performing iterations determining the texture and opacity parameters to obtain a three-dimensional model blank/checking the consistency between the three-dimensional model blank thus obtained and the images. This makes it possible to rapidly and easily improve the accuracy of the grid and thus to limit the number of defects in the final model.

According to optional features, used individually or fully or partly in combination:
the method comprises an operation of ordering the triangles, along at least one direction of observation and from a position of observation, for each pixel of each image and an opacity calculation for each of said pixels;
opacity is a sigmoid function varying between −∞ and +∞;
tetrahedrisation comprises the operation of determining a bounding box around the point cloud and the operation of constructing tetrahedra on the point cloud from each angle of the bounding box;
the method comprises a loop for returning to determining the opacity and texture parameters of the triangles if the consistency is less than an expected consistency, the loop implementing a gradient backpropagation method for iteratively converging the opacity and texture parameters of the triangles towards an optimal configuration;
comparing the model blank with the images leads to the calculation of a consistency score;
the consistency score is, for example, an error calculated between the model blank and the images by the least squares method;
when the errors are accumulated over a series of several images, an optimisation procedure is used to adapt the parameters of the triangles, in order to minimise the least squares error;
the method comprises the step of implementing an external heuristic technique to remove the triangles of the triangular grid which are least likely to belong to the three-dimensional surface, the heuristic technique involving the conditions for obtaining the point cloud and at least one feature of the triangles.

Other features and advantages of the invention will emerge upon reading the description below of a particular and non-limiting embodiment of the invention.

### BRIEF DESCRIPTION OF THE DRAWINGS

Reference will be made to the accompanying drawings, among which:

FIG. 1 is a schematic view of an example of an installation enabling the implementation of the method of the invention;

FIG. 2 is a block diagram illustrating the method of the invention;

FIG. 3 is a perspective view of a point cloud, the positions of which have been determined on the surface of one of the wings of the Victory of Samothrace;

FIG. 4 is a perspective view of a grid blank obtained from this point cloud (same view angle as FIG. 3);

FIG. 5 is a perspective view illustrating the finalisation of the grid (same view angle as FIG. 4);

FIG. 6 is a perspective view of the grid blank obtained from the point cloud of FIG. 3, but from a view angle different from that of FIG. 4;

FIG. 7 is a perspective view of the final grid (same view angle as FIG. 6).

### DETAILED DESCRIPTION

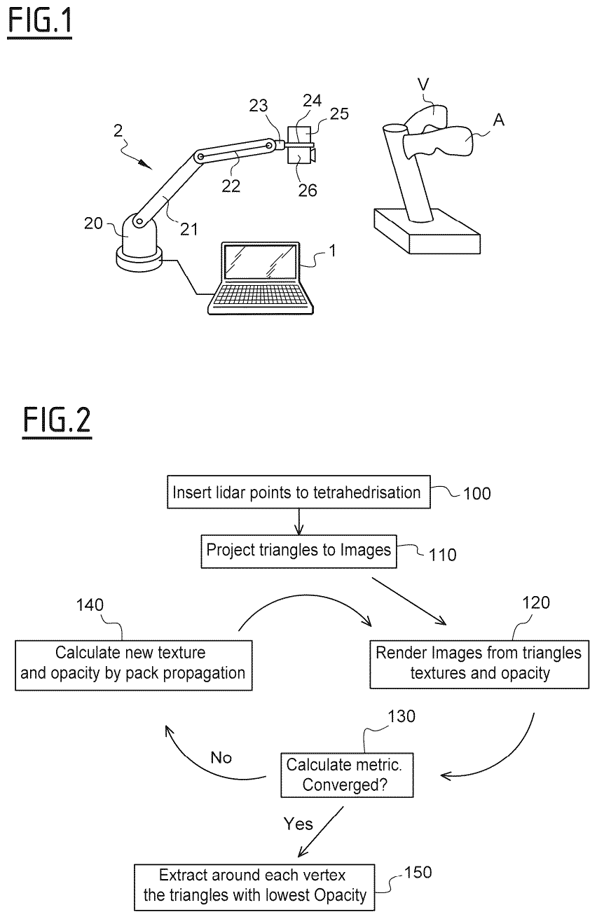

The invention relates to a method for creating a three-dimensional digital model representative of an object, in this case the end part of one of the wings of the statue called the Victory of Samothrace and kept in the Louvre Museum (the statue and the wing are symbolised as V and A in FIG. 1). It is reminded that, at the end of implementing the method according to the invention, the three-dimensional digital model must be able to be observed along a large number of axes or directions of observation (hereinafter referred to as the directions of observation which can be considered).

In reference to FIG. 1, the method according to the invention is implemented by means of an installation comprising a computer 1 and a three-dimensional measuring arm 2 connected to the computer 1.

The three-dimensional measuring arm 2, in this case, comprises a base 20, a first segment 21 articulated on the base 20, a second segment 22 articulated on the first segment 21, a wrist 23 articulated on the second segment 22. The wrist 23 is provided with an accessory support plate 24 on which a laser transceiver 25 of the LIDAR type and an image capture device 26 of the camera type are fixed, which both point in the same direction.

Each hinge axis of the three-dimensional measuring arm 2 is provided with an angular encoder connected to a first bus connected to the computer 1. The angular encoders transmit to the computer 1 signals representative of the relative angular positions of the elements of the arm between which they are disposed.

The laser transceiver 25 and the image capture device 26 are connected to a second bus connected to the computer 1. The laser transceiver 25 transmits to the computer 1 signals representative of measurements of distance between the laser transceiver 25 and points on the wing A towards which the laser transceiver 25 is pointed. The image capture device 26 transmits to the computer 1 signals representative of images of the wing A captured at the same time as the measurements of distance provided by the laser transceiver 25.

The computer 1 executes a program arranged to implement the method of the invention.

The computer 1 is programmed in a manner known per se to be able to calculate at each moment, the position of the accessory support plate 24 from the signals provided by the angular encoders and to deduce from these, in a reference frame, the coordinates of the points of the wing A for which a measurement of distance has been taken and the orientation of the accessory support plate 24 for each measurement/image capture.

The three-dimensional measuring arm 2 will be handled and controlled by an operator to rotate around the wing A and take measurements of a plurality of points distributed over the entire surface of the wing A. At the same time, photographs are also captured and recorded with the coordinates of the point from which each photograph has been taken (shooting point) and the axis along which each photograph has been taken (shooting axis).

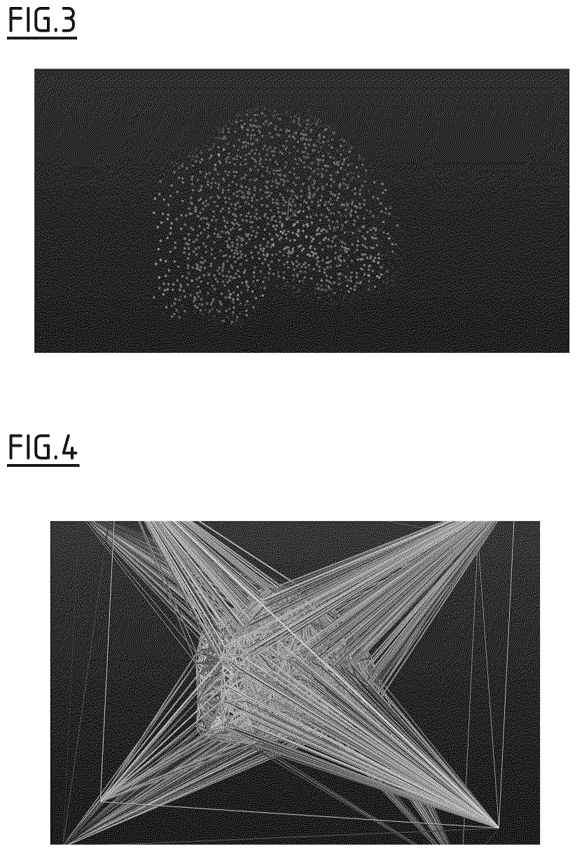

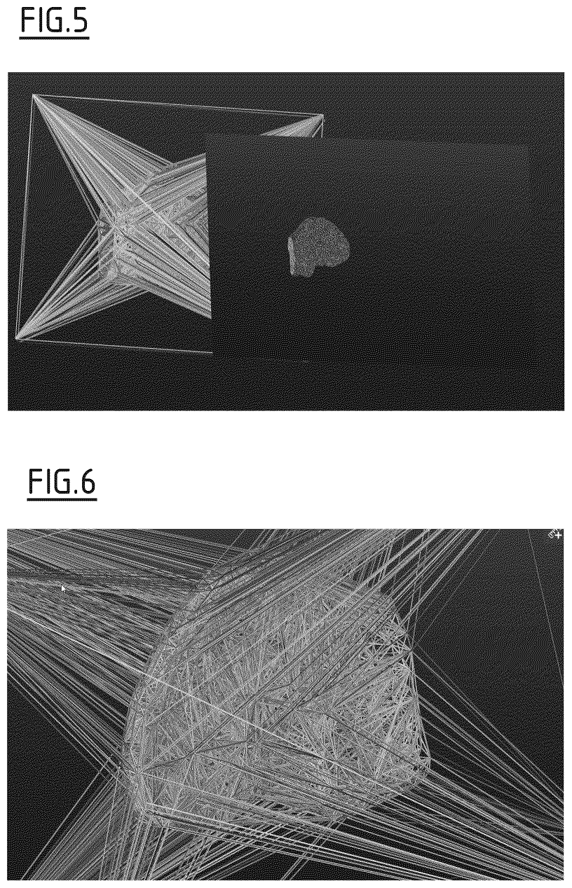

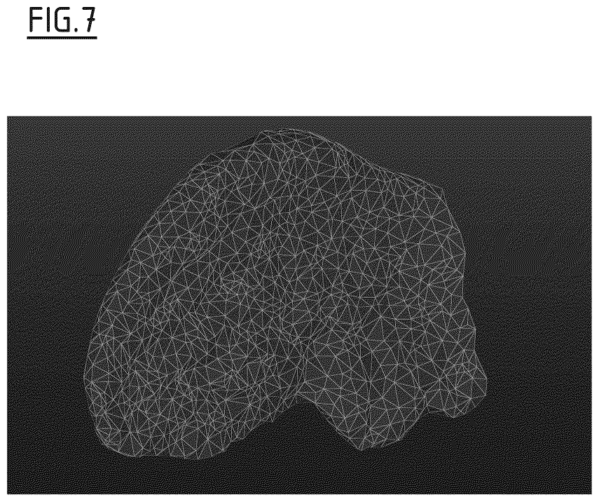

The computer 1 records all of these data to obtain a point cloud such as that represented in FIG. 3.

It is understood that, at this stage of implementing the method, the point cloud and photographs are disposed, the shooting point and the shooting axis of which are known.

The method according to the invention aims to create a three-dimensional model which can be observed along different angles, including angles for which there are no photographs.

From this point cloud, the computer 1 program constructs a polygonal grid (step 100 of the flowchart of FIG. 2). The program executed by the computer 1 more specifically implements a conventional tetrahedrisation algorithm for constructing a tetrahedral grid on the point cloud. It is reminded that a tetrahedron is a polyhedron with four triangular faces and that, in a grid of tetrahedra respecting the Delaunay condition, all the points of the point cloud are vertices of tetrahedra, such that the sphere circumscribed to each of the tetrahedra is empty, i.e. does not contain any of the points of the point cloud.

Tetrahedrisation comprises the operation of determining a bounding box around the point cloud and the operation of creating tetrahedra on the point cloud (including the angles of the bounding box).

It is understood that the points of the point cloud form the vertices of the triangular faces of the tetrahedra coming from the tetrahedrisation and make it possible to obtain a triangular grid (see FIG. 4). In a variant, a sampling of the points can be performed, such that all the points are not in the grid.

The triangular grid is then projected onto the images (step 110). The projection performed, known in itself, is a simple projection of a three-dimensional space on a plane (the plane of each photograph) along the normal to the plane. This is particularly easy for photographs taken with a standard lens or a telephoto lens. That said, projections are also known making it possible to project three-dimensional spaces onto photographs taken with very wide-angle or Hypergon lenses (for example, a fisheye-type lens).

There are necessarily triangles which do not belong to the surface of the wing A and the method of the invention preferably provides for the step of implementing an external heuristic technique to remove the triangles of the triangular grid which are least likely to belong to the three-dimensional surface, the heuristic technique involving the conditions for obtaining the point cloud and at least one feature of the triangles. Implementing the external heuristic technique makes it possible to reduce the number of eligible triangles (i.e. likely to belong to the surface of wing A) to refine the constitution of the triangular grid. For example, if points have been measured on two opposite faces of wing A, all the triangles between the two faces have no reason to exist and will therefore be removed. According to another example, if points have been measured on the surface of wing A every centimetre, all triangles the sides of which have a length greater than a threshold (for example, two centimetres) are removed. The external heuristic technique thus implemented is advantageous, as it saves time.

Once the triangles which are not eligible to belong to the surface of the wing A have been removed, the projection is used to assign to each triangle, a value of an opacity parameter and a value of a texture parameter (step 120), as will now be seen.

Beforehand, the computer 1 program has established, for each pixel (or image element) of each image, an ordered list of all the triangles which are crossed by one of the directions of observation corresponding to each shooting direction of one of the photographs. It is understood that there are, for each pixel and each direction of observation, at least two triangles: one located on the front face of the wing A and the other located on the rear face of the wing A. The computer 1 will thus determine the order in which the triangles are passed through by following the direction of observation from the theoretical viewer (the camera) located at the origin of this direction of observation (the shooting axis). This ordering will be used to determine the opacity of each triangle, being understood that the maximum opacity is theoretically attributed to the first triangle passed through by the direction of observation (or triangle of rank 1, that which is closest to the theoretical viewer and is therefore visible by said viewer along this direction of observation). It is understood that the order of the triangles is linked to the geometry of the wing A. The opacity, commonly referenced a, is a numerical value between 0 (opaque) and 1 (transparent). Preferably, the opacity is defined by a sigmoid function varying between −∞ and +∞. It is thus determined to what extent each of the triangles contributes to each pixel as a function of its opacity.

The texture parameter itself reflects the colour c of the triangle and depends on the colour of the triangle itself (which is in the foreground and is referenced

$${c}_{f =} {c}_{N}^{eff} )$$

but also on the background colour, i.e. the mixture of the colours of all the triangles visible by transparency behind the triangle in question. It is therefore understood that each triangle of rank i can thus be defined by one and/or the other of the following values

$${c}_{i}^{eff} = ( {α}_{i} {c}_{i} + ( 1 - {α}_{i} ) {c}_{i}^{eff} {α}_{i - 1}^{eff} ) / {α}_{i}^{eff}$$

$${α}_{i}^{eff} = {α}_{i} + ( 1 - {α}_{i} ) {α}_{i - 1}^{eff}$$

in which αₜ et cᵢ are respectively the opacity and colour parameters of the triangles. It will be noted that, with a sigmoid parameterisation, the factor (1-αᵢ) can never be negative. By applying this relationship recursively from the last triangle to the first visible triangle, an effective visibility per triangle can be established from a pixel and the final colour/opacity

$${c}_{N}^{eff} , {α}_{N}^{eff}$$

of the pixel can be calculated, rendered by the volume representation after having passed through N triangles. It is to be noted that for this calculation, an automatic differentiation library is used to facilitate backpropagation (the drifts

$$\frac{\partial {c}_{N}^{eff}}{\partial {α}_{i}} , \frac{\partial {c}_{N}^{eff}}{\partial {c}_{i}} , \frac{\partial {α}_{N}^{eff}}{\partial {α}_{i}}$$

can also be established by hand). It is to be mentioned that there are variants of alpha composing and that any rendering method which is differentiable and comprises an aspect of opacity could be used instead.

This technique is called “alpha compositing” and is known per se from the document, Pat Hanrahan, Image Compositing, CS148 Introduction to Computer Graphics and Imaging, Lecture 14, Winter 2009 (https://graphics.stanford.edu/courses/cs148-09/lectures/imaging.pdf) or from the document, https://en.wikipedia.org/wiki/Alpha_compositing.

The method comprises an initialisation phase and an optimisation phase aiming to iteratively converge the opacity and texture parameters of the triangles towards an optimal configuration.

During the step 120, the computer 1 superimposes to each triangle, the image(s) corresponding to each triangle to modify the texture and opacity parameters of each triangle.

During implementing the step 120 in the initialisation phase, one same texture parameter value will be applied to all the triangles passed through by one same direction of observation or to all the triangles covered by one same image: for example, all the triangles are green, or all the triangles are red. In a variant, to increase the speed of convergence of the texture parameters towards an optimal configuration during the optimisation phase, the program in the initialisation phase calculates a mean of the textures of the images covering one same triangle and applies this mean to the texture parameter value of this triangle. Any other arbitrary value could however be used in the initialisation phase.

In the same way, during the implementation of the step 120 in the initialisation phase, one same opacity parameter value will be applied to all the triangles: for example, the opacity parameter value is set to 0.5, as this will be closer to reality than having all the transparent or opaque triangles. Choosing such an intermediate value makes it possible to converge the opacity parameters more rapidly towards an optimal configuration during the optimisation phase and therefore to lead more rapidly to the three-dimensional model. However, there are other options. For example, the value of the opacity parameter initially chosen for each triangle depends on the size of the triangle: the smaller a triangle, the more points there are in the zone where this triangle is located and the more likely it is that this triangle is visible. An arbitrary value could also be chosen.

In the step 120, the computer 1 program has therefore assigned to each triangle, a value for the opacity parameter and a value for the texture parameter.

A rendering of the grid forming a model blank is thus obtained.

The model blank is then compared to the images and a consistency score is calculated between the model blank and the images (step 130). For example, this consistency score is a difference calculated by the least squares method or mean square error (MSE) and is then compared to a predetermined threshold corresponding to an acceptable consistency which depends on the accuracy of the three-dimensional model that is sought to be obtained.

The blank resulting from an initialisation phase, the consistency score is less than the predetermined threshold and the program starts the optimisation phase by starting a loop (140) to return to determining opacity/texture (step 120).

The optimisation phase is arranged to modify both the texture parameter and the opacity parameter of the triangles: the idea is to obtain values of the texture and opacity parameters of each triangle, such that the model blank best covers the images.

The loop implements a gradient backpropagation method; the use of such a loop in the field of image processing is known, for example in application to Gaussian variables in the so-called Gaussian Splatting method, and corrects the parameters of each triangle according to the importance of the contribution of each triangle to a pixel. This method makes it possible to iteratively converge the opacity and texture parameters of the triangles towards an optimal configuration. This amounts to looking for a minimum to a cost function. The gradient backpropagation method is, in this case, implemented by automatic differentiation computer programs, such as those present in the software library of the TORCH deep machine learning computer system. When the errors are accumulated over a series of several images, it is possible to use an optimisation procedure to adapt the parameters of the triangles, in order to minimise the least squares error.

In the step 120, the computer 1 program has therefore assigned to each triangle, a new value for the opacity parameter and a new value for the texture parameter. A value c can therefore be determined for each pixel and along each direction of observation.

A rendering of the grid is thus obtained, forming a new model blank: in FIG. 5, the grid being produced can be seen on the left-hand side, and the model blank can be seen on the right-hand side.

The model blank is then compared to the images and the consistency score is calculated between the model blank and the images (step 130).

If the consistency score is less than the predetermined threshold, the program borrows the loop (140) to return to the opacity/texture determination (step 120) to once again modify the texture parameter and the opacity parameter of the triangles.

It is understood that in the method of the invention, the vertices of the triangles and the triangles themselves remain the same; only the opacity and texture parameters will be modified.

When the consistency score reaches the predetermined threshold, the surface of the model blank is extracted by choosing the triangles having the greatest opacity (step 150), i.e. the lowest opacity parameter value, and this surface becomes the three-dimensional digital model of the wing A.

It will be noted that the method of the invention combines rendering techniques, known as tetrahedrisation and other rasterisation, ray tracing, texture mapping, alpha compositing, etc.

Naturally, the invention is not limited to the embodiment described, but covers any variation entering into the scope of the invention, such as defined by the claims.

In particular, the installation for implementing the method of the invention can be different from that described.

Some of the processing can be performed in the arm or, on the contrary, all the processing is performed in the computer 1.

The three-dimensional measuring arm can be replaced by any means for determining coordinates of points on the surface, by contact or without contact. For example, it is possible to use a portable LIDAR which incorporates means for detecting its own position (inertial unit, for example) or which is associated with tracking means.

Photographs can be taken at the same time as distance measurements or at another moment. All that is needed to be known, is from which point each photograph has been taken. Photographs can be captured by implementing a photogrammetric structure from motion (SFR) interval imaging method. A three-dimensional measuring arm could be had, and a dedicated support for an image capture apparatus, of which, upon each shot, the position in a common frame with the three-dimensional measuring arm could be known.

The texture parameter can comprise one or more values, or return to a texture atlas to which the computer 1 has access.

The least squares method is not compulsory and any other method making it possible to achieve a consistency verification can be used, like, for example, an entropy minimisation method.

As it can be difficult to define a threshold corresponding to sufficient consistency between the images and the model blank, this consistency can be verified by using another method.

In the method of the invention, during the initialisation phase, the opacity can be chosen, then the texture can be projected, to have a better initialisation of the texture or, conversely, the texture can be chosen, then the opacity can be projected, to have a better initialisation of the opacity.

1. Method for digitally modelling a three-dimensional surface, comprising the steps of: determining coordinates of points on the three-dimensional surface to obtain a point cloud and capturing images of the three-dimensional surface from a plurality of viewpoints, constructing a grid of triangles on the point cloud by tetrahedrisation, projecting the grid onto the images and simultaneously determining an opacity parameter and a texture parameter of the triangles by coinciding at least some of the images and the grid, in order to obtain a three-dimensional model blank, comparing the three-dimensional model blank to the images and verifying consistency between the three-dimensional model blank and the images; returning to determining the opacity and texture parameters of the triangles if the consistency is less than an expected consistency, extracting the surface from the model blank to form the three-dimensional model, otherwise.

2. Method according to claim 1, wherein determining the opacity and texture parameters comprises an operation of ordering the triangles, according to at least one direction of observation and from a position of observation, for each pixel of each image and an opacity calculation for each of said pixels, such that
$${α}_{i}^{eff} = {α}_{i} + ( 1 - {α}_{i} ) {α}_{i - 1}^{eff}$$
with
$${α}_{i}^{eff}$$
the final opacity of the pixel after having passed through i triangles and αᵢ the opacity of the pixel of triangle i.

3. Method according to claim 2, wherein the opacity is a sigmoid function varying between −∞ and +∞.

4. Method according to any one of the preceding claims, wherein the tetrahedrisation comprises the operation of determining a bounding box around the point cloud and the operation of constructing tetrahedra on the point cloud from each angle of the bounding box.

5. Method according to any one of the preceding claims, comprising a loop for returning to determining the opacity and texture parameters of the triangles if the consistency is less than an expected consistency, the loop implementing a gradient backpropagation method for iteratively converging the opacity and texture parameters of the triangles towards an optimal configuration.

6. Method according to claim 5, wherein comparing the model blank with the images leads to the calculation of a consistency score.

7. Method according to claim 6, wherein the consistency score is, for example, an error calculated between the model blank and the images by the least squares method.

8. Method according to claim 7, wherein when the errors are accumulated over a series of several images, an optimisation procedure is used to adapt the parameters of the triangles, in order to minimise the least squares error.

9. Method according to any one of the preceding claims, comprising the step of implementing an external heuristic technique to remove the triangles from the triangular grid, which are least likely to belong to the three-dimensional surface, the heuristic technique involving the conditions for obtaining the point cloud and at least one feature of the triangles.
